(19) United States
(12) Patent Application Publication
(10) Pub. No.: US 2004/0249321 A1
(43) Pub. Date: Dec. 9, 2004

(54) Massage system, particularly designed for installation inside the backrest of a vehicle seat

(76) Inventors: Ulrike Grueger, Ulm (DE); Petra Reiber, Jengen (DE)

Correspondence Address: BILL R. NAIFEH, 12655 NORTH CENTRAL EXPRESSWAY, TENTH FLOOR, SUITE 1014, LB 55, DALLAS, TX, 75243, US

(21) Appl. No.: 10/490,874

(22) PCT Filed: Sep. 27, 2002
(86) PCT No.: PCT/EP02/10880

(30) Foreign Application Priority Data
Sep. 28, 2001 (DE) 201 16 001.3
Jan. 8, 2002 (DE) 202 00 216.0
Apr. 2, 2002 (DE) 202 050116.1
May 8, 2002 (DE) 202 07 288.6

(51) Int. Cl. A61H 15/00

(52) U.S. Cl. 601/99; 601/100; 601/102; 601/116

(57) ABSTRACT

The invention relates to a massage device (1) comprising at least one massage means (2, 2′, 2A, 2A′; 20) comprising at least one massage member (3 to 6 or 21 to 23) as well as a retaining member (7, 8 or 24) for the massage members. A drive (9; 26) for the massage means (2 to 2A′; 20) and transmission means (10, 10′; 25) for transmitting a massage movement from the drive (9; 26) to the massage device (1) are provided, in particular for installation in the seat back (11) of a vehicle seat (S). The retaining member (7, 8; 24) and the transmission means (10, 10′; 25) are combined to a functional unit effecting a multi-function massage and the output shaft (19; 27) of the drive (9; 26) is directly coupled to the functional unit.

The invention relates to a massage device according to the preamble of claim 1.

A generic massage device is known from EP 0 913 42 A2. Based on the disadvantages of conventional massage devices, the invention described in this document has the object to provide a massage device having a simple structure, which can be manufactured at a lower price than conventional massage devices and thereby offers an acceptable massage effect. Further, it shall be achieved that the massage device can be installed into the seat back of a massage seat.

In order to achieve this object, the generic massage device is provided with a frame, in the longitudinal direction of which a hollow tubular guiding is provide, in which in turn a threaded rod is disposed. A threaded block is screwed onto the threaded rod, said block being guided inside the hollow tubular guiding while being supported at the inner walls thereof. The threaded rod is driven by a gear motor such that the threaded block is moved up and down in a vertical direction upon rotation of the threaded rod, dependent on the rotational direction of the gear motor.

The tubular guiding, the threaded rod and the threaded block thus constitute a transmission device for transmitting a massage motion from the gear motor forming the drive to a massage device. In the generic massage device, the massage device comprises two retaining plates arranged parallel to each other, at which a plurality of massage members in the form of massage wheels is supported. The massage plates are in turn fixed to the threaded block by means of flaps.

According to the description of EP 0 913 142 A2, the generic massage device may only perform a stretching massage, despite the still complex structure, in that the massage device and its massage members are moved up and down inside the frame.

In order to solve this problem, a further massage device, which corresponds to the generic massage device in its basic structure, is known from EP 1 034 770 A2. In this device, a vibrating device is provided in the area of the retaining members for the massage members, which should result in a further massage effect. However, this results in additional expenditure for additional parts and in particular, as in case of the generic massage device, in a relatively large installation depth due to the large number of single parts. This installation depth, however, is extremely disadvantageous for a use in the seat back of massage seats, in particular massage seats for vehicles, as in particular in case of vehicle seats, often only a small space is available to integrate the massage device into the seat back.

The problem of space especially existing in case of an installation in vehicle seats is even more prominent in massage devices known from DE 199 52 301 A1, EP 1 048 281 A1 and EP 0 836 464 B1. In these massage devices, the assembly requirements are even higher due to a still larger number of parts, and mostly several gear motors and in particular even more complicated and more complex lever arrangements are used as transmission and retaining devices for the massage members, which increases the installation depth even more compared to the generic massage device. In case of the last-mentioned massage devices, the installation depth is in particular increased due to the fact that the transmission means of the massage devices are frequently arranged in a vertical direction or at least in a nearly vertical direction with respect to the massage surface, onto which the massage members have an effect.

It is therefore an object of the present invention to provide a massage device of the kind as described in the preamble portion of claim 1, with which it is possible to perform a multi-function massage and to simultaneously decrease the number of required parts vis-a-vis the conventional massage device and to reduce therewith in particular the installation depth of the inventive massage device to a minimum.

The solution of this object is achieved by the features of claim 1.

Due to the fact that the retaining member and the transmission means are combined in one functional unit which enables a multi-function massage and due to the measure that the input shaft is directly coupled to the functional unit of the drive (i. e. without providing further transmission members), there results the advantage that the installation depth is substantially only dependent on the dimensions of the drive. However, as the installation depth of the drive may be reduced to very small values due to the conventional drives being available, e. g. electric motors, there results the advantage that the inventive massage device makes installation depths of a maximum of 70 mm possible, which enables the integration into massage vehicle seats without any problem.

The multi-function massage being possible with the inventive massage device is effected by a kind of tumbling motion of the massage members, which includes a component of motion in the direction of the massage surface, at which the massage members are disposed, as well as a component parallel to said massage surface. Further, it is possible to combine said tumbling motion with an additional component of motion perpendicular to the component of motion parallel to the massage surface.

Therewith, a fully adequate massage is achieved with the inventive massage device, which not only includes a mere stretching massage, as in the generic state of the art, despite the minimization of the required parts.

In spite of this circumstance, the inventive massage device does not require to provide e. g. additional vibrating means, as the retaining member and the transmission means are combined to a functional unit which effects the multi-function massage.

The sub-claims contain advantageous further developments of the invention.

A particularly advantageous embodiment of the transmission means is an eccentric sleeve. The eccentric sleeve may be fixed directly on the input shaft of the drive and generates all components of motion which are required for a multi-function massage.

As an alternative, an eccentric thread insert can be used, if the output shaft of the drive is treaded.

Both embodiments have the special advantage that they may be combined together with the retaining member for the massage members to form an extremely simply structured functional unit, which may further be coupled to the output shaft of the drive in a very simple way.

In order to further reduce the installation depth of the inventive massage device, the retaining member may be formed as a lever, the orientation of which extends substantially parallel to the massage surface when in an installed state, e. g. in the seat back of a vehicle seat.

In a further preferred embodiment, the drive, the massage device and the functional unit consisting of transmission means and retaining member may be formed as an independent assembly. Said assembly may be integrated without any further parts into massage seats of any kind or supported in a frame, such that the massage device constitutes an independently active massage device, which can also be applied directly at a patient's body.

In order to generate a further massage component, it is also possible to design the aforementioned assembly to be movable additionally in a direction which is oriented perpendicular to the motion extending horizontally or parallel to the massage surface.

Different constructions are possible as driving means for this component of motion. For example, a threaded rod comprising a threaded part arranged at the input shaft can be used, wherein said threaded part can be engaged with and disengaged from the aforementioned assembly by a clutch.

It is further possible to move the assembly with the help of a cable as a driving means.

In a particularly preferred embodiment, no additional motor drive is required for said driving means, as the driving means can be operated through the drive for the massage device.

Basically, it is also possible to provide a separated drive, if e.g. the installation depth does not play a paramount role.

Basically, all kinds of motors can be used as drives, in particular gear motors. As particularly preferred embodiments, electric motors and/or hydraulic and pneumatic drives are conceivable.

Further details, features and advantages of the invention result from the following description of embodiments on the basis of the drawings.

In the figures:

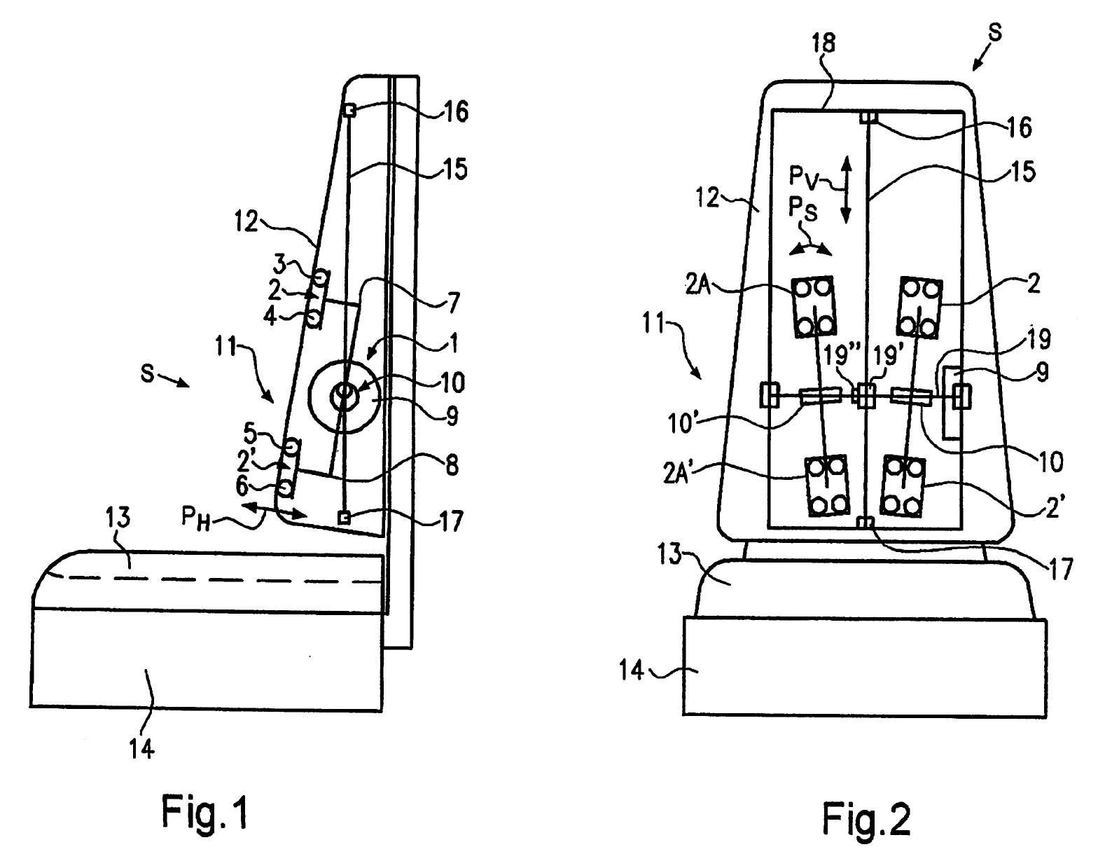

FIG. 1 is a schematically simplified side view illustrating a vehicle seat comprising an inventive massage device integrated into the seat back,

FIG. 2 is an illustration corresponding to FIG. 1 of a front view of the vehicle seat of FIG. 1,

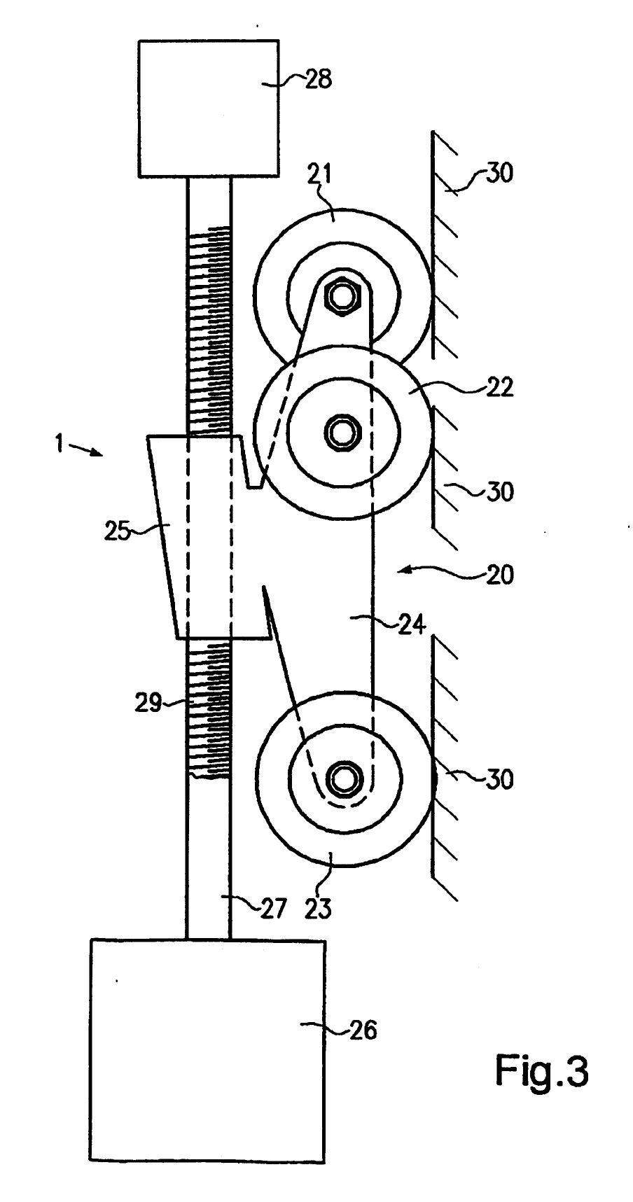

FIG. 3 is a schematically simplified illustration of a second embodiment of the inventive massage device,

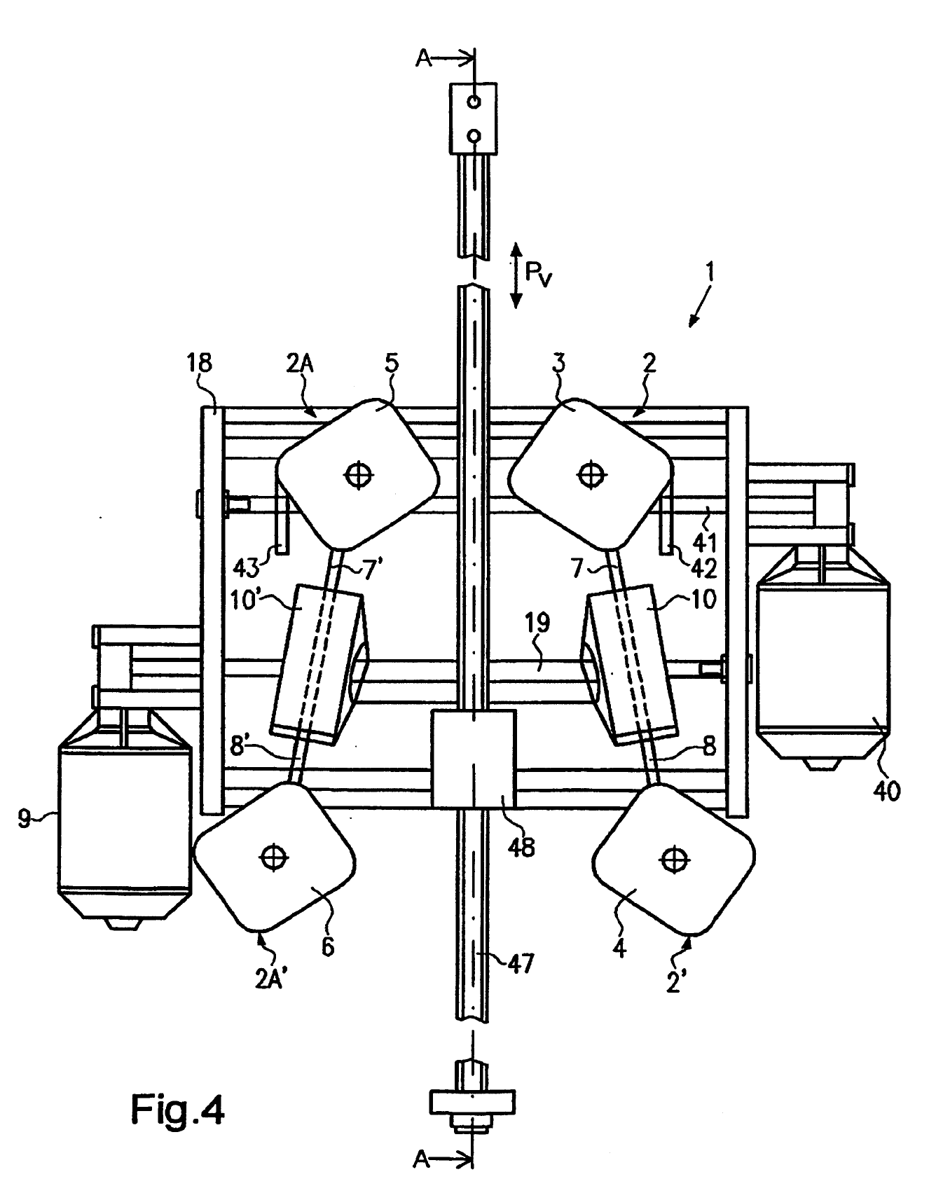

FIG. 4 is a schematically simplified illustration of a third embodiment of the inventive massage device,

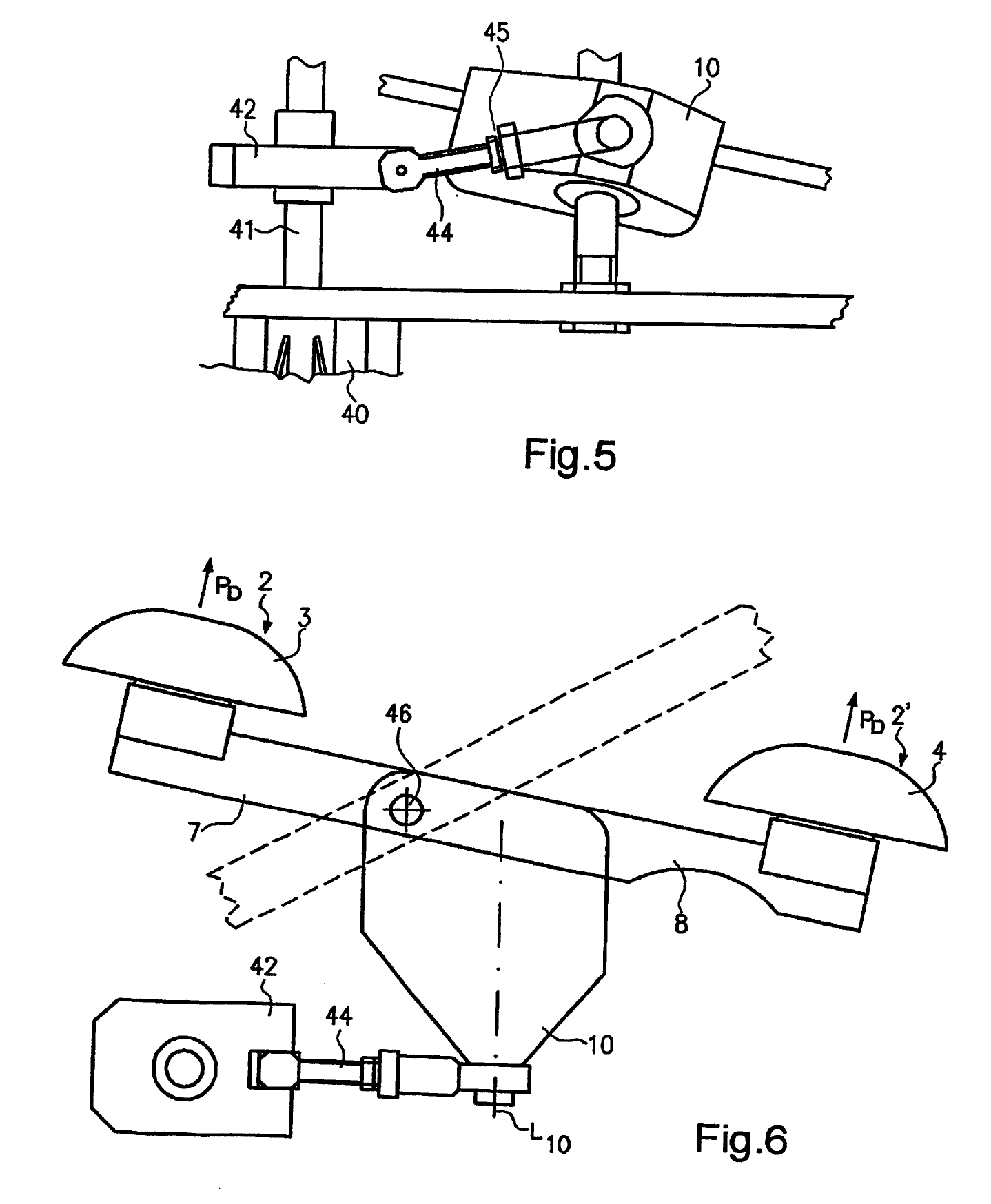

FIG. 5 is a bottom view corresponding to FIG. 4 of the embodiment according to FIG. 4,

FIG. 6 is an illustration of the embodiment of the inventive massage device according to FIG. 4 along a line A-A,

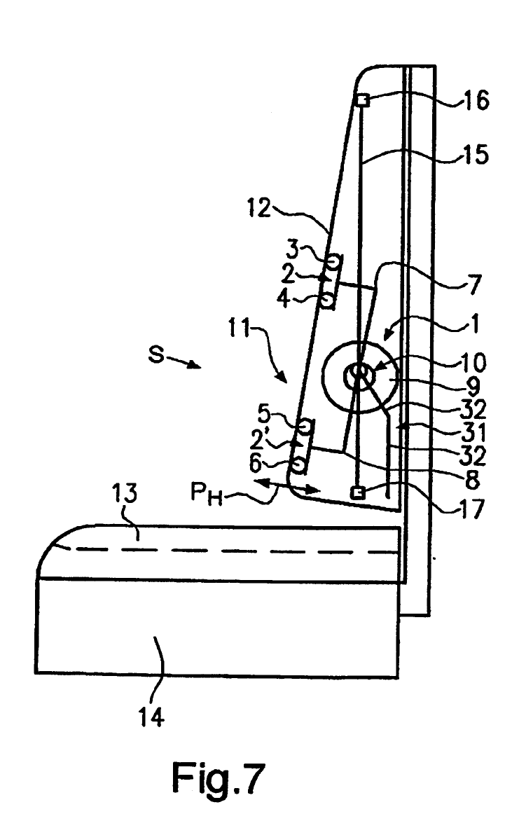

FIG. 7 is a schematically simplified illustration of a forth embodiment of the inventive massage device,

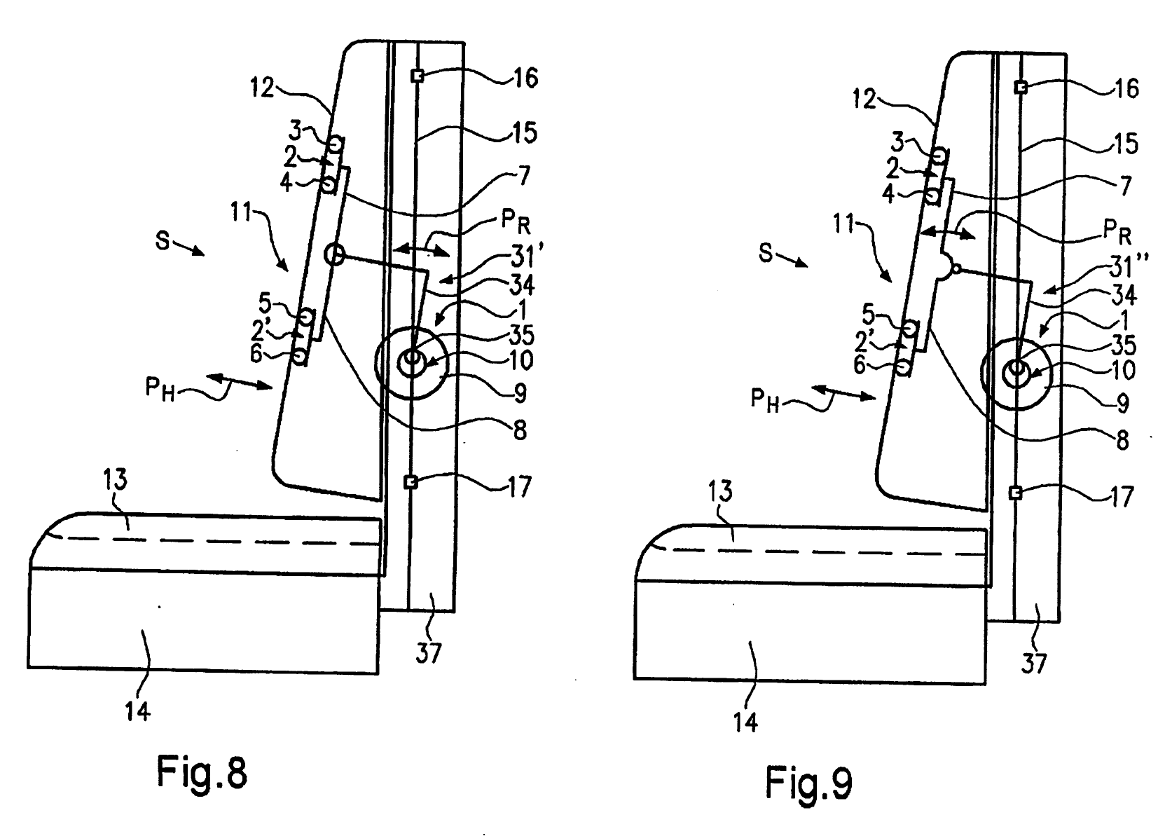

FIG. 8 is a schematically simplified illustration of a fifth embodiment of the inventive massage device, and

FIG. 9 is a schematically simplified illustration of a sixth embodiment of the inventive massage device.

FIG. 1 shows the schematically simplified illustration of a vehicle seat S, wherein an inventive massage device 1 is integrated into the seat back 11 thereof.

As is apparent from a combination of FIGS. 1 and 2, the inventive massage device 1 of the example comprises altogether four massage means 2, 2′, 2A and 2A′. The massage means 2 to 2A′ in turn comprise massage members, of which massage members 3, 4, 5 and 6 are schematically simplified shown in FIG. 1.

The massage members in turn are arranged on retaining members 7 and 8, which are formed as levers in this example. According to the illustrations of FIG. 1 and 2, two of said massage means extend above an output shaft 19 of a drive 9 and two of them extend on the opposite lower side of the output shaft 19. FIG. 1 clearly shows that the retaining members 7 and 8 form an integral lever, wherein the massage means 2 or 2′ are respectively arranged at the ends thereof.

The massage members shown in the figures may basically be provided in any number. Respectively four massage members may be preferably provided for each massage means. The massage members may be shaped as rolls, balls, wheels or in the form of any other suitable protrusion which achieves the desired massage effect. Suitable materials are rubber, plastics or even metals.

In case of the shown embodiment, the massage members 2 to 6 are fitted on a massage surface 12 which is, due to the installation into the seat back 11 of the seat 8, the surface of the seat back, against which the back of a driver is leaned.

FIGS. 1 and 2 further show that two transmission means 10 and 10′ are disposed on an output shaft 19, said means being formed as eccentric sleeves in this example, which are fixed on the output shaft 19.

Herein, the transmission means 10 and 10′ as well as the retaining members 2 and 2′ are combined to functional units which are directly coupled to the output shaft 19 of a drive 9 without interposition of further members.

In particular in FIG. 2, it is disclosed that the shown embodiment of the inventive massage device 1 is arranged in a frame 18 which may in turn be fixed in the seat back 11. The frame 18 in this example movably supports the assembly consisting of drive 9, massage means 2 to 2A′ and transmission means 10 and 10′. For this purpose, e. g. one end of the output shaft 19 and the drive 9 on the other side of the output shaft 19 may be arranged movably in the frame 18.

In the example, a winch 19′ is further supported on the output shaft 19, which can be coupled to a cable 15 through a clutch 19″. Ends 16 and 17 of the cable 15 can be fixed in the frame 18.

Therewith, a component of motion in the direction of the double arrow Pᵥ according to FIG. 2 may be generated.

In addition, a component of motion according to double arrow P_{H} in FIG. 1 is generated according to the invention, as well as a component of motion P_{S} shown in FIG. 2, which altogether results in a kind of tumbling motion of the massage members due to the overlapping of the components P_{H} und function P_{S}, which makes the initially explained multi-function massage possible.

As shown in FIGS. 1 and 2, the construction of the seat, which further comprises a seat squab 13 and a seat console 14, is not influenced by the installation of the inventive massage device 1. Further, it is shown in particular in FIG. 1 that the installation depth of the inventive massage device 1 mainly depends on the installation depth of the drive 9.

In FIG. 3, a second embodiment of an inventive massage device 1 is shown.

In this embodiment of the massage device 1, massage means 20 are provided which comprises a plate-shaped retaining member 24 for—in this example—three massage members 21, 22 and 23 formed as rolls. The massage members 21 to 23 are preferably rotatably supported at different points of the retaining plate 24. Furthermore, the massage device 1 according to the embodiment of FIG. 3 comprises a drive 26 having an output shaft 27 which comprises a treaded portion 29.

Transmission means 25 in the form of an eccentric thread sleeve are provided on the treaded portion 29, which form an integral functional unit together with the retaining member 20, said unit in turn being directly coupled to the output shaft 2 of the drive.

The free end of the output shaft 27 is supported in a bearing 28, shown simplified as a block.

In this massage device 1, a combined tumbling motion of the massage members 21 to 23 in combination with a vertical movement in the direction of the output shaft 27 is always generated by the drive 26, whereas a co-rotation of the functional unit consisting of members 25 and 24 is prevented by supporting the massage members 21, 22 and 23 at the massage surface designated by reference numeral 30. Herein, the massage surface 30 may e. g. be the inner surface of a seat back of a vehicle seat or an other massage seat or may also directly be the portion of a patient's body to be massaged.

The embodiment of the inventive massage device 1 stands out due to its extremely simple, space-saving structure, which nevertheless enables a multi-function massage.

In order to further reduce the installation depth of the inventive massage device 1, it is possible to arrange the drive 9 or 26 separately from the frame 18. This kind of arrangement of the drive 9 or 26 is e. g. advantageous if the inventive massage device 1 is intended to be installed into vehicle seats. It is possible to attach the drive 9 or 26 e. g. below the seat in the seat console or at the bottom of the vehicle and to provide a connection between the drive 9 or 26 and the outputs shaft 19 or 27, respectively, by interposition of a flexible shaft or other suitable transmission means.

Furthermore, the massage members may be fixed through joints, e. g. rubber joints, at the retaining member 7, 8 or 24.

In the following, the third embodiment is explained in detail by referring to FIGS. 4 to 6.

All parts of the massage device 1 according to the embodiment of FIGS. 4 and 6, the general structures and functions of which correspond to those of FIGS. 1 and 2, are designated with identical reference numerals. Insofar, reference is made to the explanations with respect to FIGS. 1 and 2.

A combination of FIGS. 4 to 6 shows that in this embodiment an additional drive 40 is provided to achieve an additional pressure or knocking massage direction in the direction of arrows P_{D} in FIG. 6, wherein said drive 40 may be a gear motor e. g. consisting of an electric motor and an appropriate transmission, just like the drive 9.

This drive 40 is drivingly coupled to a second output shaft 41. Said output shaft 41 is supported in the frame 18 parallel to the first output shaft 19 in this example.

At said output shaft 41, two transmission means 42 and 43 in the form of eccentrics are supported, which are in particular apparent from FIGS. 5 and 6. These two transmission means 42 and 43 are drivingly coupled to the first transmission means 10 and 10′, respectively, through respectively one connecting rod, of which the connecting rods 44 are visible in FIGS. 5 and 6. Herein, the connecting rod 44 may be provided with a length compensation designated in FIG. 5 with reference numeral 45.

As clearly shown in particular in FIG. 6, the retaining members 7 and 8 form an integral lever, which is hinged at a pivotal joint 46 at the first transmission means 10 (according to the illustration in FIG. 6). This pivotal joint 46 is attached offset to the longitudinal axis of the respective transmission means 10 or 10′. For clarification, reference is made e.g. to the longitudinal axis L₁₀ in FIG. 6.

Due to said additional drive 40 with its eccentric 42 and the connecting rod 44, it is possible to give an additional pressure or push massage motion component to the massage members 3 to 6, which is shown in FIG. 6 by the arrows P_{D}. Due to the above, there results the advantage that the massage may be further perfected, as the aforementioned component of motion is added to the massage directions explained in view of FIGS. 1 to 3.

In order to enable an up and down movement of the massage means in the direction of double arrow Pv also in the embodiment according to FIGS. 4 to 6, a threaded rod 47 is provided along which a moving block 48 can move, which enables the desired up and down movement of the massage device 1.

In the particularly preferred embodiment according to FIGS. 4 to 6, the massage members 3 to 6 have a square form with rounded corner portions when viewed from above (see FIG. 4).

Said massage heads are formed like mushrooms in side view (see FIG. 6), which enables particularly advantageous massage effects.

With reference to FIGS. 7 to 9, further preferred embodiments of the invention are described in the following.

All parts corresponding in their structure and function to the embodiments according to FIGS. 1 and 2 are designated with identical reference numerals. Insofar, reference is made to the explanations above.

In the embodiment according to FIG. 7, an additional drive 31 is provided as a further feature, said drive serving to move the massage members 3 to 6 or the complete massage means out of the plane of the massage surface 12, if needed. Such removal of the massage members from the massage surface 12 is e. g. required or desired if no massage shall be performed or in the case of an installation in a vehicle seat, in order to prevent injuries through the massage members in case of an accident.

In the embodiment shown in FIG. 7, the additional drive 31 comprises schematically simplified rail means 32, which can consist of a pair of rails, which is arranged at both longitudinal sides of the frame 18. The rail means 31 comprises a draw-in switch 32 which can be opened and closed and which is connected to the frame 18 in such a way that the massage means may draw into said draw-in switch 32, if same is opened, upon a downward movement according to FIG. 7. Through the draw-in switch 32, the massage means may then slide into a rail section 33 where it is parked in a rest position in a sufficient distance from the massage surface 12, in particular in a distance of at least 5 cm. Dependent on the case of installation, however, other distances with respect to the massage surface are conceivable. Due to its flexibility, the cable 15 allows the described evasive movement into the rails.

The drive into the rail means 31 may basically be manual or be effected by a motor drive, e. g. an electric motor.

In addition, it is possible to provide said device with an appropriate sensor unit e. g. used upon installation in the vehicle seats, in order to be able to move the massage device automatically into the aforementioned rest position in a distance from the massage surface 12 in case of e. g. an accident.

Furthermore, it shall be noted that the additional drive 31 shown in FIG. 7 may also be arranged at a different position of the frame than that shown in FIG. 7 as an example, mainly dependent on the intended use and installation.

In FIG. 8, a further embodiment is shown. This embodiment stands out due to an additional drive 31′ which also serves to move the massage members from the plane of the massage surface 12.

In the case as shown, said additional drive 31′ comprises a cranked lever 34 which hingedly supports at its free end 36 the retaining members 7, 8. The retaining members 7, 8 may be formed as a continuous lever in this embodiment, carrying the massage members 3 to 6.

At its other end 35, the lever 34 is pivotally supported at the transmission means 10 and may therefore be pivoted according to P_{R}. Herein, a pivotal motion to the right in FIG. 8 results in a movement away from the flat massage surface 12 by the respectively required distance.

In order to provide the space required for this purpose, the frame 18 in the particularly preferred embodiment shown in FIG. 8 is mounted in the seat back retracted by a distance corresponding to the distance from the massage surface 12 to be obtained. This retracted installation is shown in FIG. 8 by the schematically indicated additional housing 37.

The embodiment shown in FIG. 9 substantially corresponds to that of FIG. 8. However, concerning the illustrated lever 34 of the additional drive 31′′, its end 35 is non-rotatably coupled with the transmission means 10. In this embodiment, the free end 36 comprises a clam-shell sleeve 40 comprising two halves 38 and 39. The half 38 is connected to the retaining member 7 and the half 39 is connected to the retaining member 8 of the massage means. This means that the retaining members 7 and 8 in this case form two separate lever parts. In order to be able to move the massage members 3 to 6 out of the plane of the massage surface 12, if required, the halves 38 and 39 of the sleeve 40 can be folded in direction of the arrow P_{R}. In this case, a folding movement to the right in FIG. 6 represents a movement of the massage members 3 to 6 out of the plane of the massage surface 12.

Also in this embodiment, the frame 18 is arranged retracted with respect to the massage surface 12, which is again indicated by the housing 37.

Also in the embodiments of FIGS. 8 and 9, a manual drive of the additional drive 31′ or 31″ or a motor drive, e. g. by an electric motor, is possible. In addition, these embodiments may also be provided with a preferably electronically controlled sensor unit, if required, the design of which depends on the intended use and installation.

1. Massage device comprising
at least one massage means comprising at least one massage member and at least one retaining member for the massage members;
a drive for the massage means; and
at least one transmission means for transmitting a massage movement from the drive to the massage device, in particular for installation in the seat back of a vehicle seat;
the retaining member and the transmission means are combined to a functional unit effecting a multi-function massage; and
the output shaft of the drive is directly coupled to the functional unit.

2. The massage device of claim 1, wherein the transmission means is an eccentric sleeve.

3. The massage device of claim 1, wherein the transmission unit is fixed on the output shaft of the drive.

4. The massage device of claim 1, wherein the transmission means is an eccentric thread insert.

5. The massage device of claim 4, wherein the eccentric thread insert is arranged on a threaded portion of the input shaft of the drive.

6. The massage device of claim 1, wherein the retaining member is formed as a lever extending substantially parallel to the massage surface at which the massage member is fitted.

7. The massage device of claim 1, wherein the drive, the massage means and the functional unit constitute an assembly.

8. The massage device of claim 7, wherein the assembly is supported in a frame, preferably movably in a vertical direction.

9. The massage device of claim 8, wherein driving means for the assembly are arranged in the frame.

10. The massage device of claim 1, wherein the drive is a gear motor.

11. The massage device of claim 1, wherein a flexible driving member is provided between the drive and the output shaft.

12. The massage device of claim 1, wherein the flexible driving member is a flexible shaft.

13. The massage device of claim 11, wherein the drive is arranged outside a frame for supporting the massage means.

14. The massage device of claim 1, further comprising by a second drive being drivingly coupled to a second output shaft on which a second transmission means is supported, which is drivingly coupled to the first transmission means for generating a pressure massage component.

15. The massage device of claim 14, wherein the second transmission means is an eccentric thread insert.

16. The massage device of claim 14, further comprising a connecting rod for coupling the first transmission means to the second transmission means.

17. The massage device of claim 14, wherein the massage members are shaped square in top view and mushroom-shaped in side view.

18. The massage device of claim 1, wherein the functional unit comprises an additional drive for retracting the massage members from the plane of the massage surface.

19. The massage device of claim 18, wherein the additional drive comprises a preferably cranked lever, at the free end of which the massage members are arranged, and the other end of which is pivotally arranged at the transmission means.

20. The massage device of claim 18, wherein the additional drive comprises a preferably cranked lever, at the free end of which a clam-shell sleeve is arranged, the pivotal halves of which are connected to the massage members, whereas the other end of the lever is non-rotatably disposed on the transmission means.

21. The massage device of claim 19, wherein the frame is arranged retracted with respect to the plane of the massage surface.

22. The massage device of claim 18, wherein the additional drive comprises a pair of rails arranged at the frame and comprising respectively a draw-in switch, which can be opened and closed, for the massage means guided along the frame.

23. The massage device of claim 18, wherein the additional drive can be operated manually or by a motor (preferably by an electric motor).
